(19) United States
(12) Patent Application Publication
(10) Pub. No.: US 2021/0094583 A1
(43) Pub. Date: Apr. 1, 2021

(54) APPARATUS FOR MONITORING DRIVER, SYSTEM HAVING THE SAME, AND METHOD THEREOF

(71) Applicants: HYUNDAI MOTOR COMPANY, Seoul (KR); KIA MOTORS CORPORATION, Seoul (KR)

(72) Inventors: Eun Young CHOI, Seoul (KR); Min Sang YU, Hwaseong-si (KR); Dong Il YANG, Seoul (KR)

(73) Assignees: HYUNDAI MOTOR COMPANY, Seoul (KR); KIA MOTORS CORPORATION, Seoul (KR)

(21) Appl. No.: 16/774,303

(22) Filed: Jan. 28, 2020

(30) Foreign Application Priority Data
Oct. 1, 2019 (KR) 10-2019-0121819

(51) Int. Cl. B60W 60/00; B60Q 9/00; G08G 1/0967; B60W 50/16; G05D 1/00

(52) U.S. Cl. CPC B60W 60/0053; B60Q 9/00; G08G 1/0967; B60W 2050/143; G05D 1/0061; G05D 1/0088; B60W 50/16

(57) ABSTRACT

An apparatus for monitoring a driver in a vehicle may include: a processor to monitor a driver state based on sensing data and driver carelessness inspection logic during vehicle driving; and a display to display a notification of notifying starting of the driver carelessness inspection logic. The processor may perform the driver carelessness inspection logic, when a dangerous driving situation occurs or the driver does not look ahead of the vehicle, based on the sensing data during the vehicle driving.

### CROSS-REFERENCE TO RELATED APPLICATION

This application claims priority to and the benefit of Korean Patent Application No. 10-2019-0121819, filed on Oct. 1, 2019, the entire contents of which are incorporated herein by reference.

### FIELD

The present disclosure relates to an apparatus for monitoring a driver, a system having the same, and a method for the same, and more particularly to a technology of monitoring a driver in a self-driving vehicle.

### BACKGROUND

The statements in this section merely provide background information related to the present disclosure and may not constitute prior art.

Recently, studies and researches have been actively performed on an autonomous vehicle that is able to perform self-driving in the state that the manipulation of a driver is partially or entirely excluded.

Such an autonomous vehicle recognizes and determines the surrounding situation of the vehicle and performs driving control, but cannot completely ensure driving safety.

Accordingly, when it is difficult to ensure the safety of the driving due to the occurrence of a dangerous situation and the error or failure of software or hardware for self-driving, the driver is instantly transferred with a control to perform driving control even through the self-driving is performed.

However, we have discovered that when the driver does not recognize the requests for the transfer of the control in the state that the driver does not look ahead, a big accident may be caused. Accordingly, it is desired to monitor whether the driver inside the vehicle looks ahead of the vehicle or aside (inattentively) during the self-driving.

### SUMMARY

The present disclosure has been made to solve the above-mentioned problems occurring in the prior art while advantages achieved by the prior art are maintained intact.

An aspect of the present disclosure provides an apparatus for monitoring a driver, capable of improving the reliability for the same by monitoring the driver based on sensing data and a driver carelessness inspection logic during the vehicle driving, a system for the same, and a method for the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an apparatus for monitoring a driver in a vehicle may include: a processor to monitor a driver state based on sensing data and driver carelessness inspection logic during vehicle driving; and a display to display a notification of notifying starting of the driver careless inspection logic. The processor may perform the driver careless inspection logic, when it is determined that a dangerous driving situation occurs or that the driver does not look ahead of the vehicle, based on the sensing data during the vehicle driving.

According to one form, the processor may determine whether the dangerous driving situation occurs by using at least one of the sensing data, navigation information, or weather information during the vehicle driving.

According to one form, the dangerous driving situation may include at least one of a situation of entering a crossroad, a situation of entering a school zone, a situation of entering a major accident hazard, a situation of a vehicular traffic flow change, a situation of a sudden deceleration, a situation of a rough weather, a situation of starting a sharp turn, or a situation of approaching to a highway.

According to one form, the processor may determine the dangerous driving situation at a preset unit time interval.

According to another form, the processor may adjust the unit time interval depending on a driving road or a traffic situation.

According to one form, the processor may increase the unit time interval when the vehicle travels on an expressway, and decrease the unit time interval when the vehicle is driving in a city or in a traffic congestion area.

According to another form, the processor may notify starting of the driver carelessness inspection logic by using at least one of a haptic signal, an auditory signal, or a visual signal.

According to other form, the processor may change at least one of a size of a warning symbol displayed on the display, a change in movement of the warning symbol, a change in a color of the warning symbol, a change in a color of a mood lamp, a type of an audible alert sound, an intensity of the audible alert sound or a ringing period of the audible alert sound based on the dangerous driving situation and a general driving situation.

According to one form, the processor may output, on the display, an item to perform inspection for the carelessness of a driver to perform the driver careless inspection logic.

According to another form, the display may include a head up display device or a front display device, and the display may determine whether the driver carelessness inspection executing item is performed, in a state that the driver looks ahead.

According to other form, the driver carelessness inspection executing item may include an action to be able to be performed while the driver holds a steering wheel.

According to still other form, when the driver carelessness inspection logic is repeated in a state that the vehicle is not in the dangerous driving situation, the processor may request the driver to perform an action for a driver carelessness inspection executing item different from the driver carelessness inspection executing item which is previously performed.

According to one form, when the dangerous driving situation is maintained after the driver carelessness inspection logic is performed in the dangerous driving situation, the processor may request the driver to perform a driver carelessness inspection executing item by using a voice.

According to one form, the processor may determine whether the driver carelessness inspection executing item is performed by the driver, based on the sensing data during the vehicle driving.

According to one form, the processor may request a transfer of a control from a system to the driver when the driver carelessness inspection executing item is not performed by the driver.

According to one form, when the driver does not receive the control, the processor may stop a self-driving function and control a deceleration stop inside a road or a stop on a side road.

According to one form, the processor may provide a feedback to the driver by operating a sunroof or a side window after confirming an operation of a steering wheel when the driver does not look ahead.

According to another form of the present disclosure, a vehicle system may include a sensing device to sense whether a driver of a vehicle looks ahead of the vehicle, and a driver monitoring apparatus to sense a driver state based on sensing data by the sensing device and driver carelessness inspection logic during vehicle driving. The driver monitoring apparatus may perform the driver carelessness inspection logic, when a dangerous driving situation occurs or the driver does not look ahead of the vehicle based on the sensing data during the vehicle driving.

According to one form, the sensing device may include a photographing device to photograph a face of the driver, a first sensor to sense that the driver holds a steering wheel, and a second sensor to recognize an eye of the driver.

According to another form of the present disclosure, a method for monitoring a driver may include: determining, by a processor, whether a driving situation is a dangerous driving situation or a normal driving situation, based on sensing data during vehicle driving; determining, by the processor, whether the driver looks ahead, based on the sensing data during the vehicle driving in the normal driving situation; and performing, by the processor, driver carelessness inspection logic, when the driver does not look ahead or when the driving situation is the dangerous driving situation.

According to one form, the determining of whether the driving situation is the dangerous driving situation or the normal driving situation may include: determining whether the driving situation is the dangerous driving situation, by using at least one of the sensing data, navigation information, or weather information during the vehicle driving.

According to another form, the performing of the driver carelessness inspection logic may include: outputting a driver carelessness inspection executing item to perform the driver carelessness inspection logic; determining whether the driver carelessness inspection executing item is performed by the driver, based on the sensing data during the vehicle driving; requesting a transfer of a control from a system to the driver when the driver carelessness inspection executing item is not performed; and when the driver does not receive the control, terminating a self-driving function and controlling a deceleration stop inside a road or a stop on a side road.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a block diagram illustrating components of a vehicle system including an apparatus (hereinafter, referred to as a “driver monitoring apparatus”) for monitoring a driver;

FIG. 2 is a view illustrating screens classified according to self-driving levels;

FIG. 3 is a view illustrating a screen for monitoring a driver based on a camera image;

FIG. 4 is a view illustrating a screen for monitoring a driver based on a thermal sensor;

FIG. 5 is a view illustrating a screen for monitoring a driver based on an infrared sensor;

FIG. 6 is a flowchart illustrating a method for monitoring a driver in self-driving; and

FIG. 7 is a view illustrating a computing system.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to the exemplary drawings. In adding the reference numerals to the components of each drawing, it should be noted that the identical or equivalent component is designated by the identical numeral even when they are displayed on other drawings. Further, in describing the form of the present disclosure, a detailed description of well-known features or functions will be ruled out in order not to unnecessarily obscure the gist of the present disclosure.

In describing the components of the form according to the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

The present disclosure discloses a technology of improving the reliability of the monitoring result for the carelessness state of the driver by determining whether the driver looks ahead during the vehicle driving, by using a sensor and logic for sensing (inspecting) the carelessness of the driver.

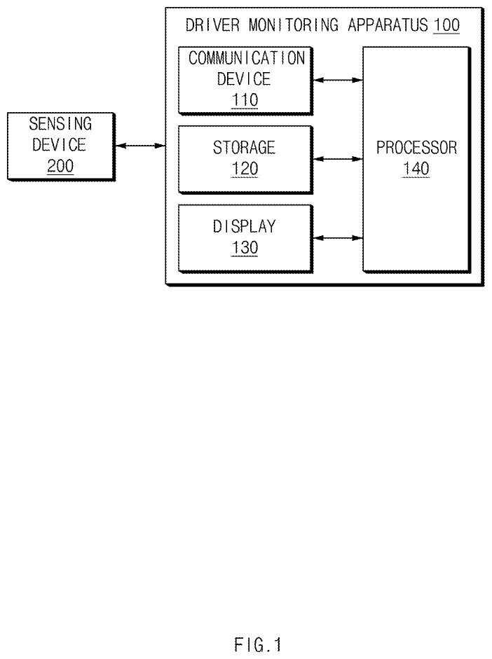

Hereinafter, forms of the present disclosure will be described in detail with reference to FIGS. 1 to 7.

FIG. 1 is a block diagram illustrating components of a vehicle system including an apparatus (hereinafter, referred to as a “driver monitoring apparatus”) for monitoring a driver, according to one form of the present disclosure.

Referring to FIG. 1, the vehicle system may include the driver monitoring apparatus 100 and a sensing device 200.

The driver monitoring apparatus 100 may monitor a driver state based on sensing data or logic (driver carelessness inspection logic) for inspecting the carelessness of a driver during the self-driving. In other words, the driver monitoring apparatus 100 may perform the driver carelessness inspection logic when it is determined that a dangerous driving situation occurs or it is determined that the driver does not look ahead of the vehicle based on the sensing data.

To this end, the driver monitoring apparatus 100 may include a communication device 110, a storage 120, a display 130, and a processor 140.

The communication device 110 is a hardware device implemented with various electronic circuits to transmit and receive a signal through wireless or wired connection. According to the present disclosure, the communication device 110 may make in-vehicle communication through controller area network (CAN) communication or local interconnect network (LIN) communication, Ethernet communication.

The storage 120 may store a sensing result of the sensing device 200 and a determination result, which is acquired by the processor 140, of a driving situation. The storage 120 may be implemented with at least one storage medium of a memory in a flash memory type, a hard disk type, a micro type, the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, or an optical disk-type memory.

The display 130 displays a self-driving situation, a screen for notifying the starting of the driver carelessness inspection logic, or a driver carelessness inspection executing item for executing the driver carelessness inspection logic, such that the driver recognizes the self-driving situation, the self-driving situation, the starting of the driver carelessness inspection logic, or the driver carelessness inspection executing item. The display 130 may be implemented with a head up display (HUD), a cluster, an audio video navigation (AVN), or a human machine interface (HMI). In addition, the display 130 may include at least one of a liquid crystal display (LCD), a thin film transistor-liquid crystal display (TFT LCD), a light emitting diode (LED), an organic light-emitting diode (OLED), an active matrix OLED (AMOLED), a flexible display, a bended display, or a third dimension (3D) display. Among them, some displays may be implemented with transparent displays configured in a transparent type or a translucence type such that the displays are viewed from the outside. In addition, the display 130 is implemented with a touchscreen including a touch panel to be used as an input device in addition to an output device.

The processor 140 may be electrically connected with the communication device 110, the storage 120, and the display 130, may electrically control each component, and may be an electric circuit that executes software commands. Accordingly, the processor 140 may perform various data processing and calculation, to be described below.

The processor 140 may monitor the driver state based on sensing data or driver carelessness inspection logic during the vehicle driving. In other words, the processor 140 may perform the driver carelessness inspection logic, when it is determined that the dangerous driving situation occurs or it is determined that the driver does not look ahead, based on the sensing data during the self-driving.

The processor 140 may determine that the dangerous driving situation occurs, by using at least one of sensing data, navigation information, or weather information during the self-driving. In this case, the dangerous driving situation may include at least one of a situation of entering a crossroad, a situation of entering a school zone, a situation of entering a major accident hazard, a situation of a vehicular traffic flow change, a situation of a sudden deceleration of the vehicle due to vehicle cutting in, a situation of a rough weather, a situation of starting a sharp turn (e.g., a sharp turn driving), or a situation of approaching to a highway.

The processor 140 may determine the dangerous driving situation at a preset unit time interval and may adjust the unit time interval depending on the driving road or the traffic situation. In other words, the processor 140 may set the unit time interval to be longer when the vehicle travels on an expressway and may set the unit time interval to be shorter when the vehicle is in city driving or in a traffic congestion state. For example, even if the vehicle travels on the expressway, when the vehicle is in the congestion area, the processor 140 may set the unit time interval to be shorter as in the city driving.

The processor 140 may notify the starting of the driver carelessness inspection logic by using at least one of a haptic signal, an audible signal, or a visual signal. The processor 140 may change at least one of the size of a warning symbol displayed on the display 130, the change in movement of the warning symbol, the change in the color of the warning symbol, the change in the color of a mood lamp, the type of an audible alert sound, the intensity of the audible alert sound or the ringing period of the audible alert sound depending on a dangerous driving situation, and a general driving situation.

The processor 140 may output, to the display 130, a driver carelessness inspection executing item for executing the driver carelessness inspection logic. In this case, the display 130 may be an HUD or a front display device positioned at the front portion of the vehicle. Accordingly, the processor 140 may determine whether the driver carelessness inspection executing item is performed, in the state that the driver looks ahead. In this case, the driver carelessness inspection executing item may include an action to be able to be performed while the driver holds a steering wheel.

When the driver carelessness inspection logic is repeated in the state that the vehicle is in the dangerous driving situation, the processor 140 may request the driver to perform an action for a driver carelessness inspection executing item different from the driver carelessness inspection executing item which is previously performed.

The processor 140 may request the driver to perform a driver carelessness inspection executing item by using a voice, when the dangerous driving situation is maintained after the driver carelessness inspection logic is performed in the dangerous driving situation.

The processor 140 may determine whether the driver carelessness inspection executing item is performed by the driver, based on the sensing data during the vehicle driving.

The processor 140 may request transferring a control from the system to the driver when the driver carelessness inspection executing item is not performed by the driver.

The processor 140 may stop the self-driving function and may control a deceleration stop inside a road or the stop on a side road, when the driver does not receive the control.

The processor 140 may provide the feedback by operating a sunroof and a side window after confirming the operation of the steering wheel, such that the driver is awaken.

The sensing device 200 may include a photographing device, such as a camera, to photograph the face of the driver, a first sensor to sense that the driver holds the steering wheel, and a second sensor to recognize eyes of the driver.

The first sensor may include a thermal sensor to sense heat generated from the steering wheel, a capacitive sensor to sense the capacitance of the steering wheel, or a torque sensor to sense the variation of a torque. The first sensor may include all various sensors to sense whether the driver holds the steering wheel with the hand of the driver.

The second sensor, which may include an infrared sensor or an electric field sensor to sense eye movement, may include various sensors to sense the eyes.

In addition, the sensing device 200 may include a rain sensor or an illuminance sensor to sense the weather.

As described above, although a system form monitoring the driver using an existing sensor requires additional sensor costs, and has problems in a sensor result and operating reliability, the present disclosure may improve the reliability for the monitoring result of the driver without requiring the additional material cost and may enlarge a target to be controlled in feedback. For example, when that the driver does not look ahead is determined as being associated with the drowsiness of the driver, the sunroof or the side window is operated after confirming the operation of the steering wheel, such that the driver is awaken.

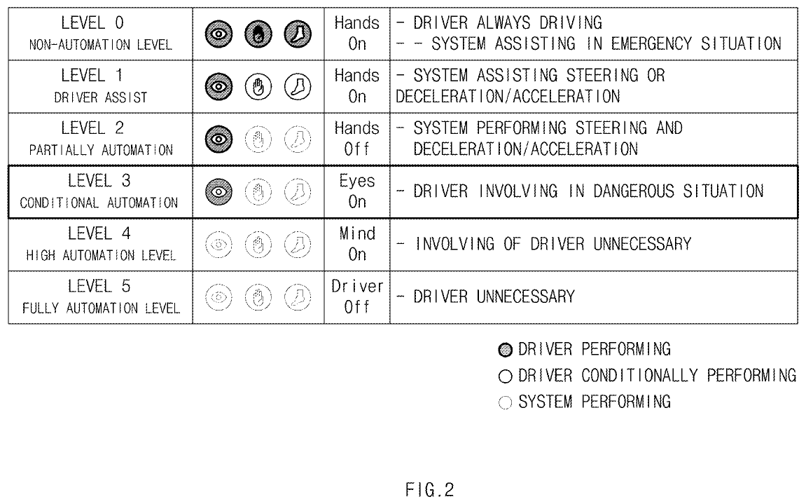

FIG. 2 is a view illustrating screens classified depending on self-driving levels, according to one form of the present disclosure.

The self-driving levels may be defined while being classified into level 0, level 1, level 2, level 3, level 4, and level 5. The level 0 is a non-automation level representing a mode in which the driver always drives. The level 1 is an assist level for the driver, and the system assists the steering or the control in deceleration or acceleration. In this case, the driver has to maintain a hands-on state at level 0 and level 1. The level 2 is a partially automation level in which the system performs the steering and the control in deceleration or acceleration, and the hands-off state of the driver may be possible.

The level 3 is a conditional automation level in which the driver is involved only in the dangerous driving situation and has to maintain that the driver looks ahead. The level 4 is a high automation level in which it is unnecessary for the driver to be involved, and the level 5 is a fully automation level in which the involvement of the driver is not required.

The present disclosure provides a technology of monitoring whether a driver looks ahead, in the conditional automation level, which is level 3, in which the monitoring is primarily performed based on a sensor utilizing a camera, and a driver carelessness (attention) inspection logic is secondarily performed when the dangerous driving situation occurs or it is not sensed that the driver looks head, thereby doubly performing the driver monitoring. Accordingly, the reliability for the monitoring result may be increased.

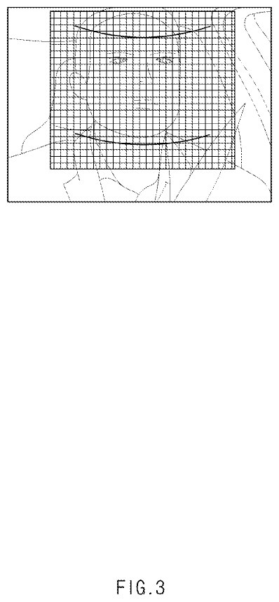

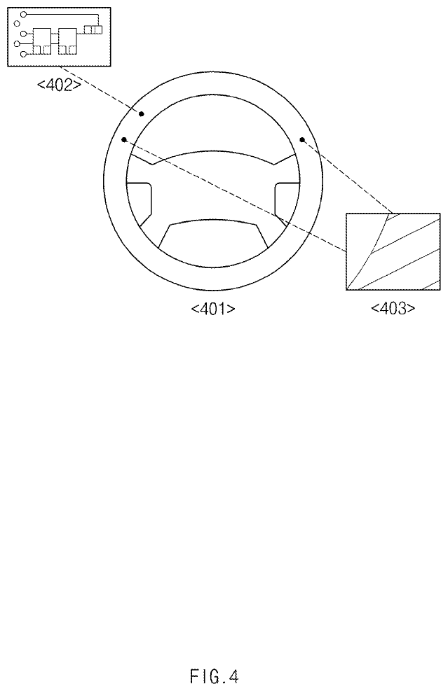

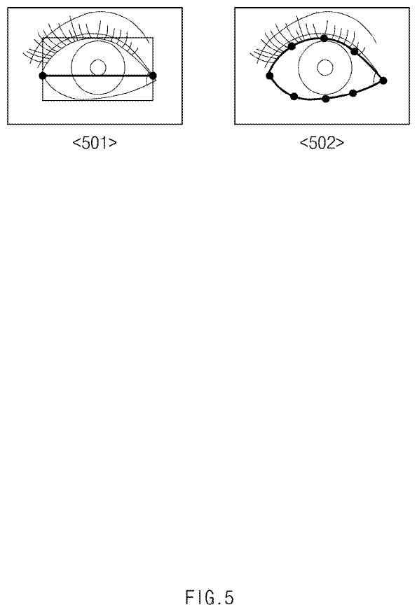

FIG. 3 is a view illustrating a screen for monitoring the driver based on a camera image, according to one form of the present disclosure, FIG. 4 is a view illustrating a screen for monitoring the driver based on a thermal sensor, according to one form of the present disclosure, and FIG. 5 is a view illustrating a screen for monitoring a driver based on an infrared sensor, according to one form of the present disclosure.

The driver monitoring apparatus 100 may determine whether the driver looks ahead by detecting the angle of the face and the direction of the pupil of the eye as the face of the driver is recognized from the image of the camera as illustrated in FIG. 3. However, providing a plurality of cameras is limited in cost and a mounting space.

The driver monitoring apparatus 100 may determine whether the driver holds the steering wheel 401, by using the thermal sensors 402 and 403 embedded in the steering wheel 401 as illustrated in FIG. 4 and may determine that the driver looks ahead when the driver holds the steering wheel 401. However, sensing errors may be caused as drivers have different holding positions and habits and there may be caused an abnormal situation that a hand-off self-driving system is recognized as being in a hands-on state.

The driver monitoring apparatus 100 may determine whether the driver looks ahead by recognizing the eyes of the driver using the infrared sensor as illustrated in FIG. 5. Reference numeral 501 is an example of detecting the diameter of an eye, and reference numeral 502 is an example of determining whether the driver looks ahead by detecting the contour of the eye. However, when the driver puts on sunglasses or glasses, the sensing errors may be caused depending on light and a refractive index, and the recognition rate of the eye may be varied as drivers have eyes in various shapes.

Therefore, according to the present disclosure, it is primarily monitored whether the driver looks ahead through cameras, thermal sensors, or infrared sensors. Then, when it is sensed that the dangerous driving situation occurs or it is not sensed that the driver looks ahead after the primarily monitoring has been performed, and the driver carelessness (attention) inspection logic is secondarily performed, thereby dually performing the monitoring of the driver. Accordingly, the reliability for the monitoring result may be improved.

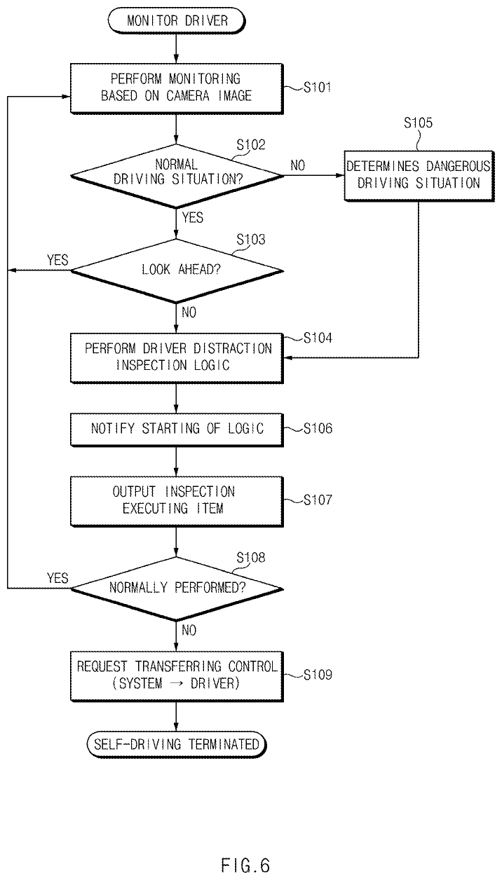

Hereinafter, a method for monitoring a driver in self-driving will be described with reference to FIG. 6 in detail, according to one form of the present disclosure. FIG. 6 is a flowchart illustrating the method for monitoring the driver in the self-driving.

Hereinafter, it is assumed that the driver monitoring apparatus 100 of FIG. 1 performs the process of FIG. 6. In addition, in the following description made with reference to FIG. 6, it may be understood that the operation described as being performed by the driver monitoring apparatus 100 is controlled by the processor 140 of the driver monitoring apparatus 100.

Referring to FIG. 6, the driver monitoring apparatus 100 performs driver monitoring based on a camera image to monitor the driver (S101).

Accordingly, the driver monitoring apparatus 100 determines whether a present situation is a normal driving situation (S102). When the present situation is not the normal driving situation, the driver monitoring apparatus 100 determines the dangerous driving situation (S105).

In this case, the normal driving situation is not the dangerous driving situation, and the driver monitoring apparatus 100 may determine whether the preset situation is the dangerous driving situation by using the sensing device 200 such as an illuminance sensor, a vehicle speed sensor, or a rain sensor, navigation information, or infotainment weather information. In this case, the dangerous driving situation may include at least one of a situation of entering a crossroad, a situation of entering a school zone, a situation of entering a major accident hazard, a situation of changing a vehicular traffic flow, for example, a situation of decelerating from 100 kph to 60 kph in highway driving, a situation of making a sudden deceleration due to another vehicle which is cutting in, a situation of sensing a cloudy weather suddenly changed by a rain sensor and an illuminance sensor, a situation of receiving rough weather information, a situation before starting of running into a vehicle sharp turn based on navigation information, or a situation of closing to a highway.

In this case, the driver monitoring apparatus 100 may determine whether the present situation is the normal driving situation, at a preset unit time interval. In addition, the driver monitoring apparatus 100 may set a cycle (unit time interval) to be longer to determine whether the vehicle is the normal driving situation when the vehicle travels on the expressway, and may set the cycle (unit time interval) to be shorter in city driving. In addition, when the vehicle is able to perform a higher-level self-driving function, the driver monitoring apparatus 100 may adjust the cycle to be longer to determine whether the present situation is the normal driving situation to be suitable to the self-driving level of the vehicle.

When the present situation is the normal driving situation in step S102, the driver monitoring apparatus 100 determines whether the driver looks ahead, based on image data obtained from the camera (S103).

In the state that the driver looks ahead, the driver monitoring apparatus 100 may continuously monitor the driver using the camera.

To the contrary, when it is not determined that the driver looks ahead, based on the camera image data, the driver monitoring apparatus 100 may perform the driver carelessness (distraction) inspection logic (S104).

In other words, when the abnormal carelessness of the driver is sensed in monitoring the driver based image from the camera, the driver carelessness (distraction) inspection logic is performed to monitor the driver at the two stages.

When the present situation is the normal driving situation but the driver does not look ahead, or when the present situation is the dangerous driving situation, the driver monitoring apparatus 100 may perform the driver carelessness (distraction) inspection logic (S104).

The driver monitoring apparatus 100 notifies the starting of the driver carelessness (distraction) inspection logic (S106) and outputs the driver carelessness inspection executing item for inspecting the driver carelessness (S107). In this case, the driver monitoring apparatus 100 may output the driver carelessness inspection executing item to the HUD at the front portion of the vehicle or the front display, thereby determining whether the driver normally performs the driver carelessness inspection executing item in the state that the driver looks ahead.

In this case, the driver monitoring apparatus 100 notifies the driver of the starting of the driver carelessness (distraction) inspection logic, such that the driver has time to prepare for the driver carelessness (distraction) inspection logic. The driver monitoring apparatus 100 may notify the starting of the driver carelessness (distraction) inspection logic in the form of a pop-up message on the display 130 or the audible or tactile form. In addition, the driver monitoring apparatus 100 may notify the starting of the driver carelessness (distraction) inspection logic by using at least one of a haptic signal (seat or steering vibration), an audible signal, or a visual signal (an output through AVN, HUD, or a mood lamp).

Further, the driver monitoring apparatus 100 may provide information for the driver by distinguishing between the normal driving situation and the dangerous driving situation, such that the driver notifies the present driving situation.

For example, the driver monitoring apparatus 100 may change the size of a warning symbol displayed on the display 130, the change in movement of the warning symbol, color differentiation in the color of the warning symbol, the change (green→red) in the color of a mood lamp, the type of an audible alert sound, the intensity of the audible alert sound or the ringing period of the audible alert sound, such that the driver intuitively recognizes the present driving situation.

[symbol]

The driver monitoring apparatus 100 may display, on the display 130, the driver clearness inspection executing item. The driver clearness inspection executing item may include an action to be performed by the driver while holding the steering wheel. In addition, the driver clearness inspection executing item may include an action taken when the hand of the driver is positioned on the steering wheel and when the eyes of the driver face the HUD. For example, the action performed when the hand of the driver is positioned on the steering wheel and the eyes of the driver face the HUD may include a function of recognizing voice input information by receiving a wiper operation, audio-volume control, or a present speed through a microphone, a function, such as lighting-on function, performed through a button on the steering wheel, or a function performed by a multi-function switch.

Alternatively, when the driver carelessness inspection logic is secondarily and periodically repeated in the normal driving situation, the driver monitoring apparatus 100 requires an action different from an action first output on the display 130 such that the driver concentrates on driving. In addition, the driver monitoring apparatus 100 may change the color of a mood lamp and the audible alarm sound to improve awareness.

In addition, when a secondary driver carelessness inspection logic is first performed once in the dangerous situation and then additional determination is desired as it is determined that the dangerous driving situation is maintained, a next secondary driver carelessness inspection logic may be performed by utilizing only a voice result to separate from a part desired for the driving, such that the driving is not interrupted. For example, the driver carelessness inspection executing item may be set as “make this sound three times” or “tell the term of ‘front’ three times”.

Accordingly, the driver monitoring apparatus 100 may determine whether the driver carelessness inspection executing item is normally performed (S108). When the driver carelessness inspection executing item is not normally performed, the driver monitoring apparatus 100 requests the system to transfer a control to the driver (S109). In this case, the driver monitoring apparatus 100 may determine, by using the image from the camera, whether the driver carelessness inspection executing item is normally performed within a preset time.

For example, when requesting “wiper operation” as the driver carelessness inspection executing item, the driver monitoring apparatus 100 determines that the driver carelessness inspection executing item is normally performed when the driver normally performs the wiper operation. When the wiper operation is not normally performed, the driver monitoring apparatus 100 determines that the driver carelessness inspection executing item is not normally performed.

Thereafter, when the control is normally transferred from the system to the driver, the self-driving is terminated. Accordingly, the driver monitoring apparatus 100 may terminate monitoring the driver.

To the contrast, when the control is not normally transferred from the system to the driver within the preset time, the driver monitoring apparatus 100 determines that the driver is not in the normal state and thus determine the activation of the self-driving function as being impossible to perform a control operation to the driving of minimizing the danger (a deceleration stop inside a road or the stop on a side road). For example, according to the result obtained by executing the driver carelessness inspection executing item using at least two ways, when the action of the driver is not sensed for 180 seconds or more, an audible alarm rings for 15 seconds and a control transfer request (system→driver) is started.

As described above, according to the present disclosure, the driver carelessness inspection executing item is output to the driver without adding a physical sensor and whether the driver normally performs the driver carelessness inspection executing item is checked, thereby monitoring the driver with higher reliability.

In addition, according to the present disclosure, a control target, such as a sunroof as well as the steering wheel, for a feedback may be enlarged when the driver does not look ahead.

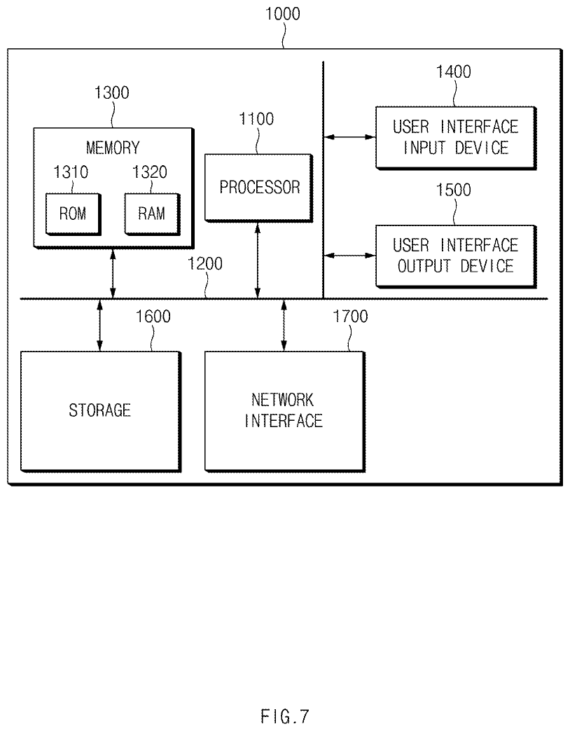

FIG. 7 illustrates a computing system, according to one form of the present disclosure.

Referring to FIG. 7, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device for processing instructions stored in the memory 1300 and/or the storage 1600. The memory 1300 and the storage 1600 may include various types of volatile or non-volatile storage media. For example, the memory 1300 may include a read only memory (ROM) and a random access memory (RAM).

Thus, the operations of the methods or algorithms described in connection with the forms disclosed in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside in a driver terminal. Alternatively, the processor and the storage medium may reside as separate components of the driver terminal.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary forms of the present disclosure are provided to explain the spirit and scope of the present disclosure, but not to limit them, so that the spirit and scope of the present disclosure is not limited by the forms. The scope of the present disclosure should be construed on the basis of the accompanying claims, and all the technical ideas within the scope equivalent to the claims should be included in the scope of the present disclosure.

As described above, according to the present technology, the reliability for the driver monitoring result may be improved by monitoring the driver based on the sensing data and the driver carelessness inspection logic during the vehicle driving.

Besides, a variety of effects directly or indirectly understood through the disclosure may be provided.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. An apparatus for monitoring a driver in a vehicle, the apparatus comprising:
a processor configured to monitor a driver state based on sensing data and driver carelessness inspection logic during vehicle driving; and
a display configured to display a notification that identifies a start of the driver carelessness inspection logic,
wherein the processor is further configured to:
perform the driver carelessness inspection logic, when a dangerous driving situation occurs or the driver does not look ahead of the vehicle, based on the sensing data during the vehicle driving.

2. The apparatus of claim 1, wherein the processor is configured to:
determine whether the dangerous driving situation occurs by using at least one of the sensing data, navigation information, or weather information during the vehicle driving.

3. The apparatus of claim 1, wherein the dangerous driving situation includes:
at least one of a situation of entering a crossroad, a situation of entering a school zone, a situation of entering a major accident hazard, a situation of a vehicular traffic flow change, a situation of a sudden deceleration of the vehicle, a situation of a rough weather, a situation of starting a sharp turn, or a situation of approaching to a highway.

4. The apparatus of claim 1, wherein the processor is configured to:
determine the dangerous driving situation at a preset unit time interval.

5. The apparatus of claim 4, wherein the processor is configured to:
adjust the preset unit time interval based on a driving road or a traffic situation.

6. The apparatus of claim 5, wherein the processor is configured to:
increase the preset unit time interval when the vehicle travels on an expressway; and
decrease the preset unit time interval when the vehicle is driving in a city or in a traffic congestion area.

7. The apparatus of claim 1, wherein the processor is configured to:
notify the starting of the driver carelessness inspection logic by using at least one of a haptic signal, an audible signal, or a visual signal.

8. The apparatus of claim 1, wherein the processor is configured to:
change at least one of a size of a warning symbol displayed on the display, a change in movement of the warning symbol, a change in a color of the warning symbol, a change in a color of a mood lamp, a type of an audible alert sound, an intensity of the audible alert sound, or a ringing period of the audible alert sound based on the dangerous driving situation and a general driving situation.

9. The apparatus of claim 1, wherein the processor is configured to:
output, to the display, a driver carelessness inspection executing item for executing the driver carelessness inspection logic.

10. The apparatus of claim 9, wherein the display includes a head up display device or a front display device, and
wherein the processor is configured to:
determine whether the driver carelessness inspection executing item is performed, in a state that the driver looks ahead.

11. The apparatus of claim 9, wherein the driver carelessness inspection executing item includes an action to be able to be performed while the driver holds a steering wheel.

12. The apparatus of claim 11, wherein the processor is configured to:
when the driver carelessness inspection logic is repeated in a state that the vehicle is not in the dangerous driving situation, request the driver to perform an action for a driver carelessness inspection executing item different from the driver carelessness inspection executing item which is previously performed.

13. The apparatus of claim 11, wherein the processor is configured to:
when the dangerous driving situation is maintained after the driver carelessness inspection logic is performed in the dangerous driving situation, request the driver to perform a driver carelessness inspection executing item by using a voice.

14. The apparatus of claim 11, wherein the processor is configured to:
determine whether the driver carelessness inspection executing item is performed by the driver, based on the sensing data during the vehicle driving.

15. The apparatus of claim 11, wherein the processor is configured to:
request a transfer of a control from a system to the driver when the driver carelessness inspection executing item is not performed by the driver.

16. The apparatus of claim 15, wherein the processor is configured to:
when the driver does not receive the control, stop a self-driving function and control a deceleration stop inside a road or a stop on a side road.

17. The apparatus of claim 1, wherein the processor is configured to:
provide a feedback to the driver by operating a sunroof or a side window after confirming an operation of a steering wheel when the driver does not look ahead.

18. A vehicle system comprising:
a sensing device configured to sense whether a driver in a vehicle looks ahead of the vehicle; and
a driver monitoring apparatus configured to sense a driver state based on sensing data by the sensing device and driver carelessness inspection logic during vehicle driving,
wherein the driver monitoring apparatus is configured to perform the driver carelessness inspection logic, when a dangerous driving situation occurs or the driver does not look ahead of the vehicle, based on the sensing data during the vehicle driving.

19. The vehicle system of claim 18, wherein the sensing device includes:
a photographing device configured to photograph a face of the driver;
a first sensor configured to sense that the driver holds a steering wheel; and
a second sensor configured to recognize an eye of the driver.

20. A method for monitoring a driver of a vehicle, the method comprising:
determining, by a processor, whether a driving situation is a dangerous driving situation or a normal driving situation, based on sensing data during vehicle driving;
determining, by the processor, whether the driver looks ahead of the vehicle, based on the sensing data during the vehicle driving in the normal driving situation; and
performing, by the processor, driver carelessness inspection logic, when the driver does not look ahead or when the driving situation is the dangerous driving situation.

21. The method of claim 20, wherein determining whether the driving situation is the dangerous driving situation or the normal driving situation includes:
determining whether the driving situation is the dangerous driving situation, by using at least one of the sensing data, navigation information, or weather information during the vehicle driving.

22. The method of claim 20, wherein performing the driver carelessness inspection logic includes:
outputting a driver carelessness inspection executing item to perform the driver carelessness inspection logic;
determining whether the driver carelessness inspection executing item is performed by the driver, based on the sensing data during the vehicle driving;
requesting a transfer of a control from a system to the driver when the driver carelessness inspection executing item is not performed; and
when the driver does not receive the control, terminating a self-driving function and controlling a deceleration stop inside a road or a stop on a side road.
